(19) United States
(12) Patent Application Publication
(10) Pub. No.: US 2014/0143166 A1
(43) Pub. Date: May 22, 2014

(54) IDENTIFYING MEMBERS OF A SOCIAL NETWORK AS CANDIDATE REFERRAL SOURCES

(71) Applicants: Heyning Cheng, Los Gatos, CA (US); Robert J. Spoer, Palo Alto, CA (US); Erik H. Juhl, San Francisco, CA (US); Adrian Axel Remigo Fernandez, Mountain View, CA (US)

(72) Inventors: Heyning Cheng, Los Gatos, CA (US); Robert J. Spoer, Palo Alto, CA (US); Erik H. Juhl, San Francisco, CA (US); Adrian Axel Remigo Fernandez, Mountain View, CA (US)

(21) Appl. No.: 13/780,091

(22) Filed: Feb. 28, 2013

Related U.S. Application Data
(60) Provisional application No. 61/728,168, filed on Nov. 19, 2012.

(51) Int. Cl. G06Q 10/10; G06Q 50/00

(52) U.S. Cl. CPC G06Q 10/1053; G06Q 50/01
USPC 705/319

(57) ABSTRACT

Systems and methods for identifying members of a social network service as job referral sources are described. In some example embodiments, the systems and methods may receive or access information associated with an available job, and for a member of a social network that is affiliated with the available job (e.g., is employed by the company providing the available job), identify a connection within the social network that is a suitable job referral source by utilizing an algorithmic process that determines the suitability of members connected to the identified connection as candidates for the available job.

### CROSS REFERENCE TO RELATED APPLICATIONS

This applications claims priority to U.S. Provisional Patent Application No. 61/728,168, filed on Nov. 19, 2012, entitled IDENTIFYING MEMBERS OF A SOCIAL NETWORK AS JOB REFERRAL SOURCES, which is hereby incorporated by reference in its entirety.

### TECHNICAL FIELD

The present disclosure generally relates to providing job application services via websites. More specifically, the present disclosure relates to methods, systems and computer program products for using social network information in job application services.

### BACKGROUND

Online social network services provide users with a mechanism for defining, and memorializing in a digital format, their relationships with other people. This digital representation of real-world relationships is frequently referred to as a social graph. Many social network services utilize a social graph to facilitate electronic communications and the sharing of information between its users or members. For instance, the relationship between two members of a social network service, as defined in the social graph of the social network service, may determine the access and sharing privileges that exist between the two members. As such, the social graph in use by a social network service may determine the manner in which two members of the social network service can interact with one another via the various communication and sharing mechanisms supported by the social network service.

Some social network services aim to enable friends and family to communicate and share with one another, while others are specifically directed to business users with a goal of facilitating the establishment of professional networks and the sharing of business information. For purposes of the present disclosure, the terms “social network” and “social network service” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

With many social network services, members are prompted to provide a variety of personal information, which may be displayed in a member's personal web page. Such information is commonly referred to as “personal profile information”, or simply “profile information”, and when shown collectively, it is commonly referred to as a member's profile. For example, with some of the many social network services in use today, the personal information that is commonly requested and displayed as part of a member's profile includes a member's age (e.g., birth date), gender, contact information, home town, address, the name of the member's spouse and/or family members, a photograph of the member, interests, and so forth. With certain social network services, such as some business network services, a member's personal information may include information commonly included in a professional resume or curriculum vitae, such as information about a person's education, employment history, job skills, professional organizations, and so forth. With some social network services, a member's profile may be viewable to the public by default, or alternatively, the member may specify that only some portion of the profile is to be public by default. As such, many social network services serve as a sort of directory of people to be searched and browsed.

Because social network services are a rich source of information about people, social network services are an extremely useful tool when performing certain tasks. For example, many people use social network services to search for, and/or browse, member profiles that exhibit various desired characteristics. For instance, a job recruiter may search for persons who have profiles indicating the possession of certain technical skills, and educational and professional experiences and backgrounds. Similarly, when someone needs to hire a person employed in a particular profession (e.g., a general contractor, a doctor, a lawyer, a landscaper, a plumber, an investment banker, and so forth), that person may turn to a social network service to identify persons who possess the requisite skills and qualifications. In another scenario, a person may desire to contact someone for the purpose of exploring or proposing the possibility of a particular business arrangement or relationship. Accordingly, the person may use a social network service to identify the appropriate persons to contact.

For example, in an effort to find the best people to fill vacant positions, companies look for candidates through a variety of venues. They may post job advertisements, attend or put on job fairs, recruit on university campuses, ask employees for referrals, or look for candidates within a social network. They go to these lengths because it can be very difficult to identify candidates for vacant positions, especially talented or desired candidates. Similarly, job seekers often find it difficult to find attractive positions, even when there are many vacancies in the field.

### DESCRIPTION OF THE DRAWINGS

Some embodiments of the technology are illustrated by way of example and not limitation in the figures of the accompanying drawings.

FIG. 1 is a block diagram illustrating various functional components of a social network system with a referral identification system, consistent with some embodiments, for identifying members of a social network as job referral sources.

FIG. 2 is a block diagram illustrating an example of a portion of a graph data structure for modelling a social graph, consistent with some embodiments.

FIG. 3 is a table showing examples of the many different types of associations that may be represented with an edge connecting two nodes in a graph data structure, consistent with some embodiments.

FIG. 4 is a block diagram illustrating modules of the referral identification system, consistent with some embodiments.

FIG. 5 is a block diagram illustrating an example of connections between members within a social network service, consistent with some embodiments.

FIG. 6 is a flow diagram illustrating an example method for identifying a referral source for an available job, consistent with some embodiments.

FIG. 7 is a flow diagram illustrating an example method for identifying job candidates for an available job and performing an action associated with a job candidate, consistent with some embodiments.

FIG. 8A-8C are display diagrams depicting the display of job referral information within a social network, consistent with some embodiments.

FIG. 9 is a block diagram of a machine in the form of a computing device within which a set of instructions, for causing the machine to perform any one or more of the methodologies discussed herein, may be executed.

### DETAILED DESCRIPTION

### Overview

The present disclosure describes methods, systems, and computer program products, which individually provide functionality for identifying members of a social network as job candidate referral sources.

For example, the systems and methods described herein may receive information associated with an available job, and for a member of a social network that is affiliated with the available job (e.g., is employed by the company providing the available job), identify a connection within the social network that is a suitable job referral source by utilizing an algorithmic process that determines the suitability of members connected to the identified connection as candidates for the available job. In addition, these systems and methods may automate some aspects of the process of identifying job candidates in an employee's extended network, by facilitating communication between the employee and the job referral source with the goal of identifying suitable candidates.

A social network service is a useful location in which to obtain various types of information associated with a job candidate and/or available job, such as information identifying job referral sources for an available job. Often, a social network or other similar site, such as LinkedIn, Facebook, Google+, Twitter, and so on, stores various types of information associated with members of the site. For example, a friend-based social networking service may store interest information for a member (e.g., information about things a member “likes”), whereas a business-based social networking service may store accomplishment or experience information for a member (e.g., educational or work experience information). Additionally, a social networking service may store a variety of information associated with a member's social graph, such as information identifying other members within the member's social graph, among other things.

In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

Other advantages and aspects of the inventive subject matter will be readily apparent from the description of the figures that follows.

### Suitable System

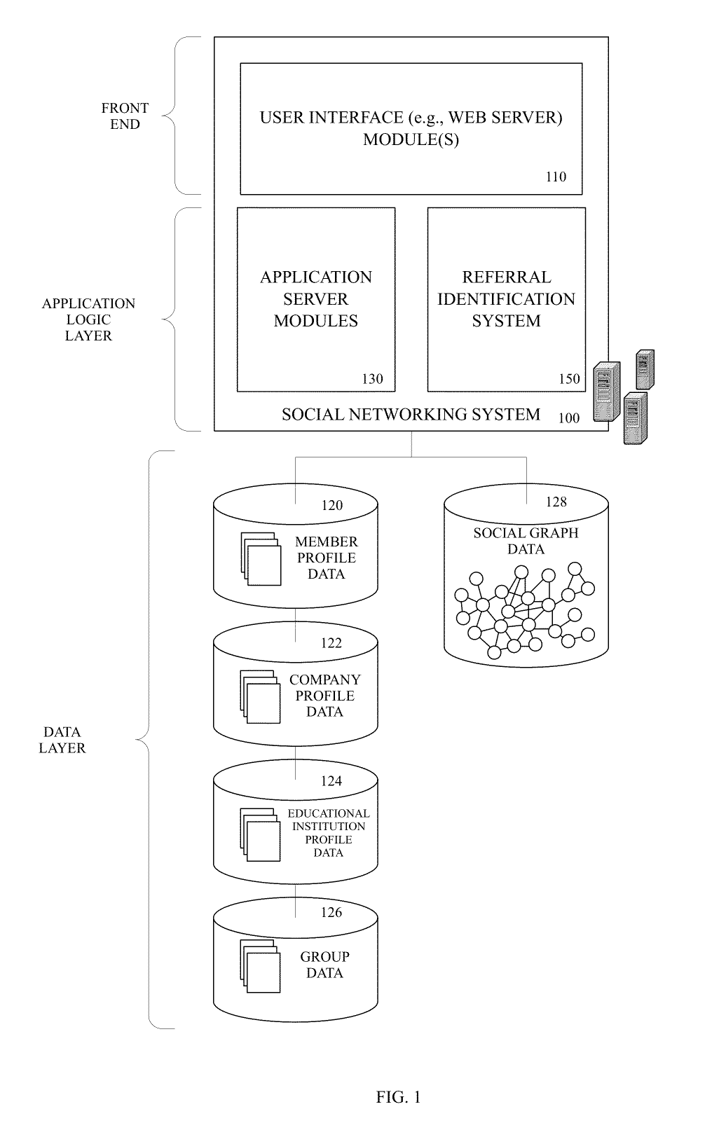

FIG. 1 is a block diagram illustrating various functional components of a social network system 100 with a referral identification system 150 for use with a wide variety of applications and specifically for identifying, and then presenting, members of the social network as job referral sources for available jobs. As shown in FIG. 1, the social network system 100 is generally based on a three-tiered architecture, consisting of a front-end layer, application logic layer, and data layer. The modules, systems, and/or engines shown in FIG. 1 represent a set of executable software instructions and the corresponding hardware (e.g., memory and processor) for executing the instructions. To avoid obscuring the inventive subject matter with unnecessary detail, various functional modules and engines that are not germane to conveying an understanding of the inventive subject matter have been omitted from FIG. 1. However, one skilled in the art will readily recognize that various additional functional modules and engines may be used with a social network system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the inventive subject matter is by no means limited to such architecture.

As shown in FIG. 1, the front end consists of a user interface module (e.g., a web server) 110, which receives requests from various client-computing devices, and communicates appropriate responses to the requesting client devices. For example, the user interface module(s) 110 may receive requests in the form of Hypertext Transport Protocol (HTTP) requests, or other web-based, application programming interface (API) requests. The client devices (not shown) may be executing conventional web browser applications, or applications that have been developed for a specific platform to include any of a wide variety of mobile devices and operating systems.

As shown in FIG. 1, the data layer includes several databases, including databases for storing data for various entities of the social graph, including member profiles 120, company profiles 122, educational institution profiles 124, as well as information concerning various online or offline groups 126. In addition, the graph data structure is implemented with a graph database 128, which is a particular type of database that uses graph structures with nodes, edges, and properties to represent and store data. Of course, with various alternative embodiments, any number of other entities might be included in the social graph, and as such, various other databases may be used to store data corresponding with other entities.

In some example embodiments, when a person initially registers to become a member of the social network service, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored, for example, as member profile data in database 120.

Once registered, a member may invite other members, or be invited by other members, to connect via the social network service. A “connection” may require a bi-lateral agreement by the members, such that both members acknowledge the establishment of the connection. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity, which may or may not be included in the social graph.

The social network service may provide a broad range of other applications and services that allow members the opportunity to share and receive information, often customized to the interests of the member. For example, in some example embodiments, the social network service may include a photo sharing application that allows members to upload and share photos with other members. As such, a photograph may be a property or entity included within a social graph.

In some example embodiments, members of a social network service may be able to self-organize into groups, or interest groups, organized around a subject matter or topic of interest. Accordingly, the data for a group may be stored in database 126. When a member joins a group, his or her membership in the group will be reflected in the social graph data stored in database 128. In some example embodiments, members may subscribe to or join groups affiliated with one or more companies. For instance, in some example embodiments, members of the social network service may indicate an affiliation with a company at which they are employed, such that news and events pertaining to the company are automatically communicated to the members. In some example embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modelled with the social graph data of database 128.

The application logic layer includes various application server modules 130, which, in conjunction with the user interface module(s) 110, generates various user interfaces (e.g., web pages) with data retrieved from various data sources in the data layer. With some embodiments, individual application server modules are used to implement the functionality associated with various applications, services and features of the social network service. For instance, a messaging application, such as an email application, an instant messaging application, or some hybrid or variation of the two, may be implemented with one or more application server modules 130. Similarly, a search engine enabling users to search for and browse member profiles may be implemented with one or more application server modules 130. Of course, other applications or services that utilize the referral identification system 150 may be separately embodied in their own application server modules 130.

In addition to the various application server modules 130, the application logic layer includes the referral identification system 150. The referral identification system 150 may include various modules and/or engines configured to receive information associated with an available job, such as job listing information, identify one or more members of a social network as referral candidates, and perform an action associated with the identified members, such as transmit requests to the identified members to refer one or more of their connections to an entity associated with the available job.

The referral identification system 150 may perform one or more algorithmic processes that, in response to receiving input information associated with an available job, return, for a given member within a social network, an identification of a connection within a social network as a job referral source when the connection is further connected to a desired number of other members deemed suitable to be candidates for the available job.

As illustrated in FIG. 1, in some example embodiments the referral identification system 150 is implemented as a service that operates in conjunction with various application server modules 130. For instance, any number of individual application server modules 130 can invoke the functionality of the referral identification system 150, to include an application server module associated with a messaging application and/or an application server module associated with an application to facilitate the viewing of member profiles. However, in various example embodiments, the referral identification system 150 may be implemented as its own application server module such that it operates as a stand-alone application. In some example embodiments, the referral identification system 150 may include or have an associated publicly available application programming interface (API) that enables third-party applications to invoke the functionality of the referral identification system 150.

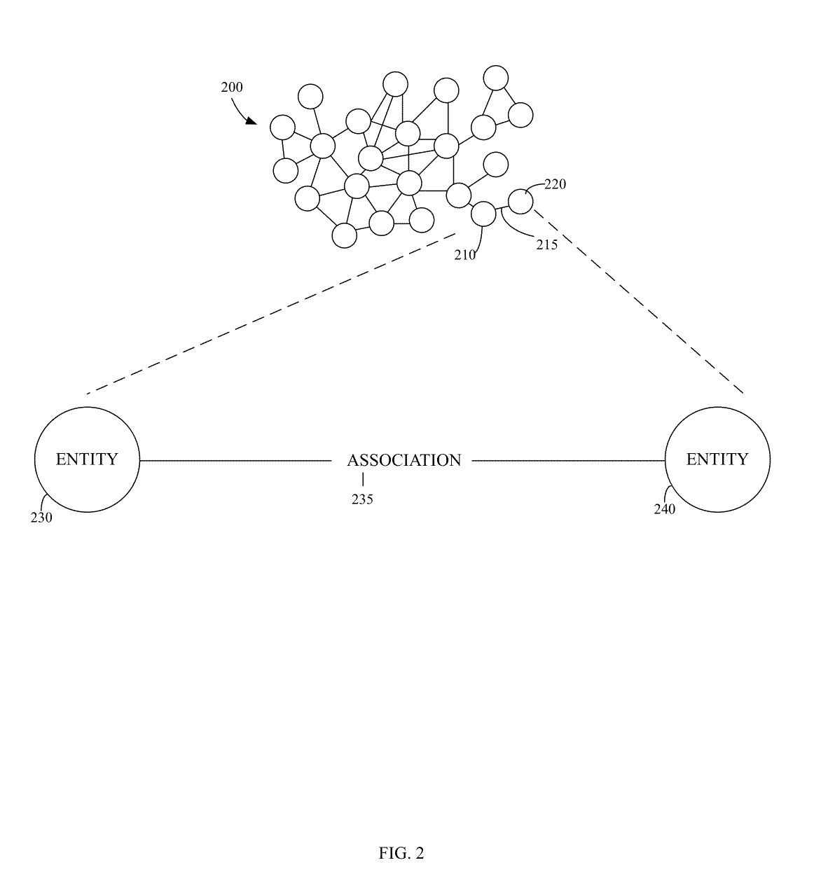

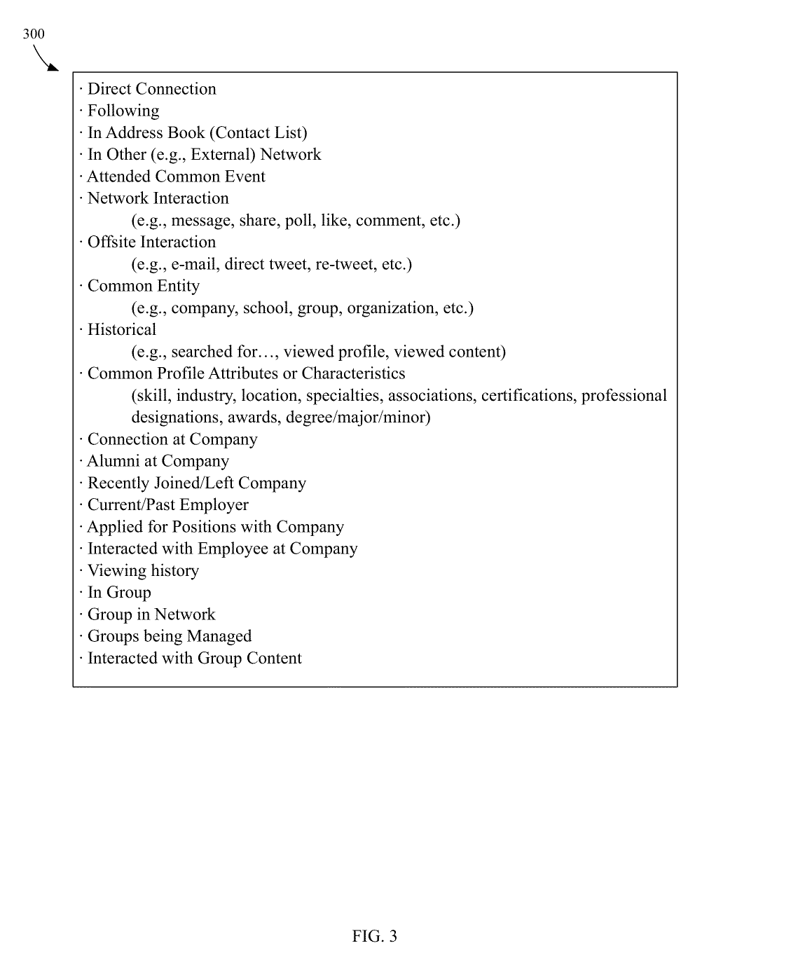

FIG. 2 is a block diagram illustrating an example of a portion of a graph data structure 200 for implementing a social graph, in some example embodiments. As illustrated in FIG. 2, the graph data structure 200 consists of nodes connected by edges. For instance, node 230 is connected to node 240 by means of edge 235. Each node in the graph data structure 200 represents an entity in the social graph. In some example embodiments, any number of entity types may be included in the social graph. For example, the entity types that exist may include: a person, a company, an educational institution (e.g., college, school or university), and a group (e.g., an online group, hosted by the social network service, or some other third party server system, or, a real-world organization, such as a professional organization). The edges that connect any two nodes can represent a wide variety of different associations. For example, in general, an edge may represent an association 235, such as a relationship, a connection, an affiliation, an activity or event, or some other affinity shared in common between two entities. Although not exhaustive, the various associations presented in the table of FIG. 3 represent some of the many associations that may be mapped to the edges of a social graph data structure to indicate the association between entities in a social graph of a social network service, among other things.

Referring to FIG. 3, the table 300 illustrates a non-exhaustive list of associations that may be attributed to an edge connecting two nodes, representing entities, in the social graph data structure. Various edge types or associations may be applicable to all combinations of entity types, while others may be applicable to only a certain subset of combinations of entity types. For example, an edge type representing a “following” relationship may connect two nodes, where each node represents a person, and the edge connecting the two nodes indicates that one person is following the other. Similarly, an edge representing a “following” relationship may connect a first node, representing a person, with a second node, representing a company, to indicate that the person is following the company. Accordingly, the edge type for a “following” relationship applies to the entity type, person, as well as company. Some other associations are only meaningful when applied to an edge connecting certain types of entities.

Some of the various associations or edge types shown in FIG. 3 indicate a particular relationship that exists between two entities represented by nodes in the graph data structure. For instance, two members of the social network service may be directly connected, one member may be following another, one member may be in an address book or contacts list of another, two members may be co-managing a group or co-inventors on a patent, and so forth. In each of these examples, the association or edge type is assigned to the edge connecting the two nodes representing the two entities (e.g., person, company, educational institution, group, etc.)

Some of the various associations or edge types shown in FIG. 3 indicate an activity that is shared in common between two entities, or an activity that involves two entities. For example, a first member may have communicated a message to a second member. A first member may have re-tweeted or forwarded some content item (e.g., a tweet) that was originally generated by a second member. A first member may share an item of content with a second member, or, comment on an item of content posted by a second member, and so forth.

A third category of associations generally involves what may be thought of as affiliations. For example, a member may be affiliated with a company based on current or past employment at the company. A member may be affiliated with an educational institution based on current or past attendance as a student. A member may be affiliated with an online group based on membership in the group.

Another general category of associations or edge types involves what are referred to herein as affinities. For instance, two members may be associated based on an affinity or similarity of profile attributes, such as, the same general geographic location, skills shared in common, employment in the same industry, common degrees or majors, etc. The various associations or edge types that may be assigned to an edge connecting two nodes in a graph data structure presented in FIG. 3 are simply some of the many examples. In some example embodiments, different associations (not shown in FIG. 3) may also be used, such as associations that have additional entity types other than the specific examples presented herein (e.g., person, company, educational institution, group).

Thus, in some example embodiments, the referral identification system 150 navigates a social graph to identify a node (e.g. the job referral source node) associated with a desired number of other nodes (e.g., members) that are suitable job candidates for an available job. Once the job referral source node is identified for a member associated with the available job (e.g., the member is an employee of the company hiring for the job), the system 150 may perform a variety of actions to refer the members determined to be suitable job candidates, among other things.

Identifying a Job Referral Source within a Social Network

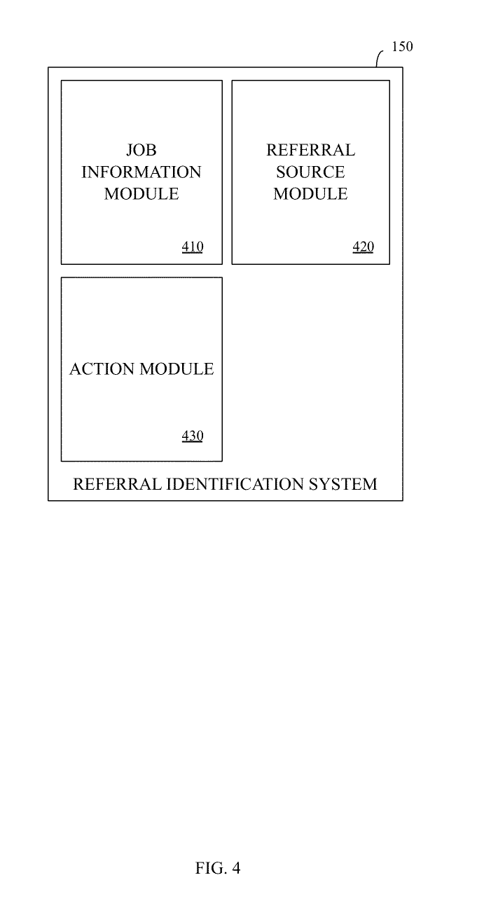

As described herein, in some example embodiments, the referral identification system 150 is configured to identify members of a social network service as referral sources for job opportunities advertised within the social network service, among other things. FIG. 4 is a block diagram illustrating modules of the referral identification system 150, consistent with some embodiments.

As illustrated in FIG. 4, the referral identification system 150 includes a variety of functional modules. One skilled in the art will appreciate that the functional modules are implemented with a combination of software (e.g., executable instructions, or computer code) and hardware (e.g., at least a memory and processor). Accordingly, as used herein, in some embodiments a module is a processor-implemented module and represents a computing device having a processor that is at least temporarily configured and/or programmed by executable instructions stored in memory to perform one or more of the particular functions that are described herein.

Referring to FIG. 4, the referral identification system 150 includes a job information module 410, a referral source module 420, an action module 430, and other modules not shown in the Figure.

In some example embodiments, the job information module 410 is configured and/or programmed to receive information associated with a job available at a company, such as job listing information. For example, the job information module 410 may receive information presented in a job listing, such as information from the following:
a job title;
a job description;
required or desired skills;
required or desired education;
required or desired experience;
name and type of company associated with the job;
location of the job; and so on.

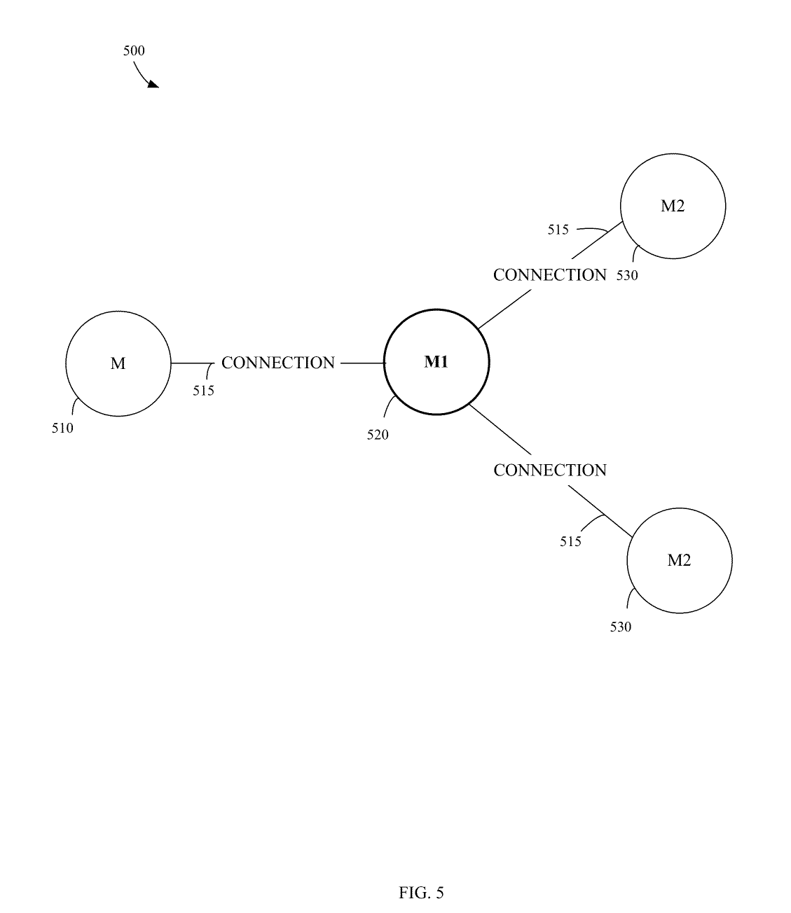

In some example embodiments, the referral source module 420 is configured and/or programmed to identify a member of a social network as a job referral source for an available job. For example, the referral source module 420 may perform an algorithmic process to identify members that are connected to a given member associated with (e.g., currently or formerly employed by) a company that is providing the available job as job referral sources, when the identified members are themselves connected to a desired or optimal group of members that may be considered suitable candidates for the available job. FIG. 5 depicts an example arrangement 500 of connections 515 between members within a social network service, consistent with some embodiments.

Using a member (M) 510 associated with a company providing an available job as a starting point, the referral source module 420 identifies a first degree connected member (M1) 520 as the job referral source based on the attributes of the first degree connected member's own first degree connected members (M2s) 530. Or, for a given member (M) 510, the referral source module 420 identified a member (M1) 520 that is connected to many different members (M2s) 530 that are suitable candidates for a job J.

In some example embodiments, the member M may be indirectly connected to the member M1 in the social network graph, via an intermediate member or via a shared affiliation with an entity such as a company.

In some example embodiments. the member M1 may be indirectly connected to the member M2 in the social network graph, via an intermediate member or via a shared affiliation with an entity, such as a company.

Referring back to FIG. 4, the referral source module 420 may perform various different algorithmic processes in order to identify and/or determine an M1 as a job referral source. The algorithmic processes may match M2s to a job based on various criteria associated with the attributes assigned to the M2s, such as criteria associated with education attributes, work experience attributes, location attributes, and so on. In some example embodiments, the algorithmic processes may select M1s and M2s based on other criteria including the strength of association between M and M1, the strength of association between M1 and M2, the number of different members M2 with which M1 is connected, and activities previously performed by M1 and M2 using the social networking service. The algorithmic processes may also exclude M1s and M2s who have been affiliated with the company providing the job. An example algorithmic process is as follows:

M is connected to M1, and M2 is connected to M1, but not to M;

Given that C(M1, M2) and C(M2, M) denote connection strengths of the direct member connections between M1 and M2, and M2 and M, respectively, and T(M2, J) denotes a score indicating the suitability of a member M2 for job J, a score for M2 with respect to the job J is calculated as follows:

Score(M2,J)=SQRT[C(M1,M2)*C(M2,M)]*T(M2,J).

A score for M1 and the job J is calculated as follows:

Score(M1,J)=SUM over M2 in M1's first degree network [Score(M2,J)].

A score for each M1 is then determined as follows:

Score(M1)=MAX over job postings J at M's employer [Score(M1,J)].

The algorithm returns the score Score (M1) for each of a member's direct connections M1, with high scores indicating a member is a suitable and/or optimal member job referral source for an available job J.

Thus, the referral source module 420 utilize various different algorithmic processes to identify the connections M1 for a member M that are suitable job referral sources for available jobs associated with a company or other entity with which the member M is affiliated.

In some example embodiments, the action module 430 is configured and/or programmed to perform an action associated with the member M1 identified as a suitable job referral source. For example, the action module 430 may cause a widget located within a page shown to the member M to display information identifying the member M1 as a suitable job referral source; may cause a widget located within a page shown to the member M1 to display information identifying the member M, the available job J, and a member M2 identified as a suitable candidate for the job; and/or perform other actions described herein with respect to the members of the social network.

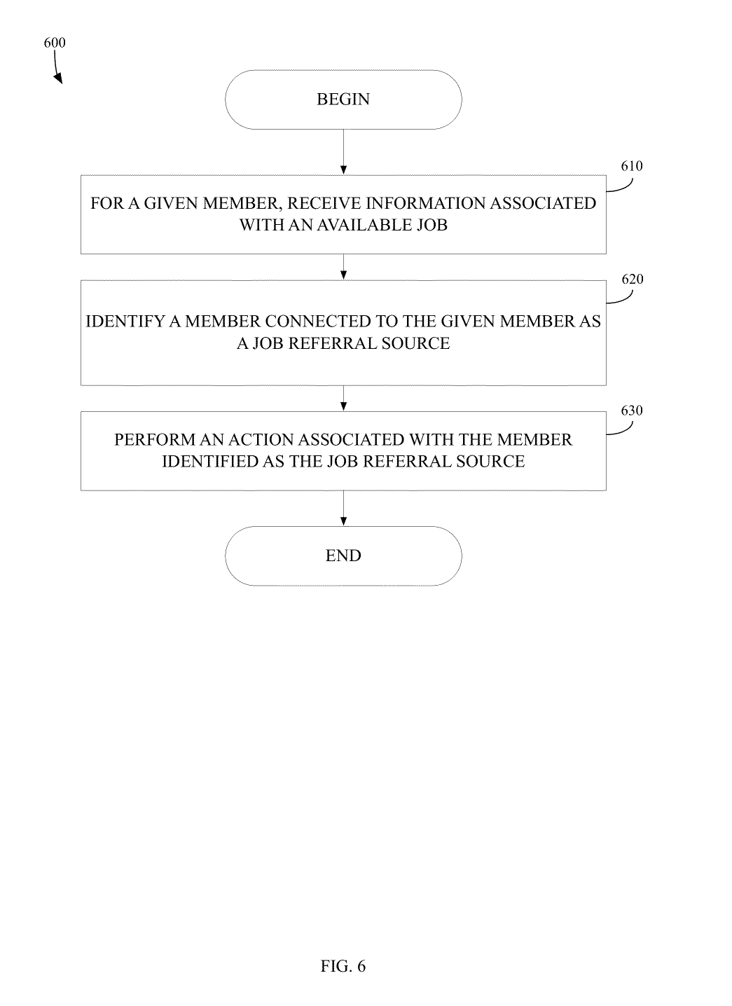

As described herein, the referral identification system 150 and/or the modules 410, 420, 430, may perform various methods in order to identify members of a social network as job referral sources and/or perform actions associated with the identified members. FIG. 6 is a flow diagram illustrating an example method 600 for identifying a referral source for an available job, consistent with some embodiments.

In operation 610, the system, for a given member, receives and/or accesses information associated with an available job. For example, the job information module 410 receives information from a job listing advertising an available job at a company that employs the given member.

In operation 620, the system identifies a member connected to the given member as a job referral source. For example, the referral source module 420 performs an algorithmic process, such as one of the algorithmic processes described herein, to identify a member as a job referral source.

In operation 630, the system enables a given member M associated with the company to perform an action associated with the identified member M1. For example, the system may notify the user via an electronic message, or via a widget displayed on the social networking site. For example, the action module 430 updates a widget to display information indicating that the member M1 that is connected to the member M is a suitable job referral source for an available job at the member M's company.

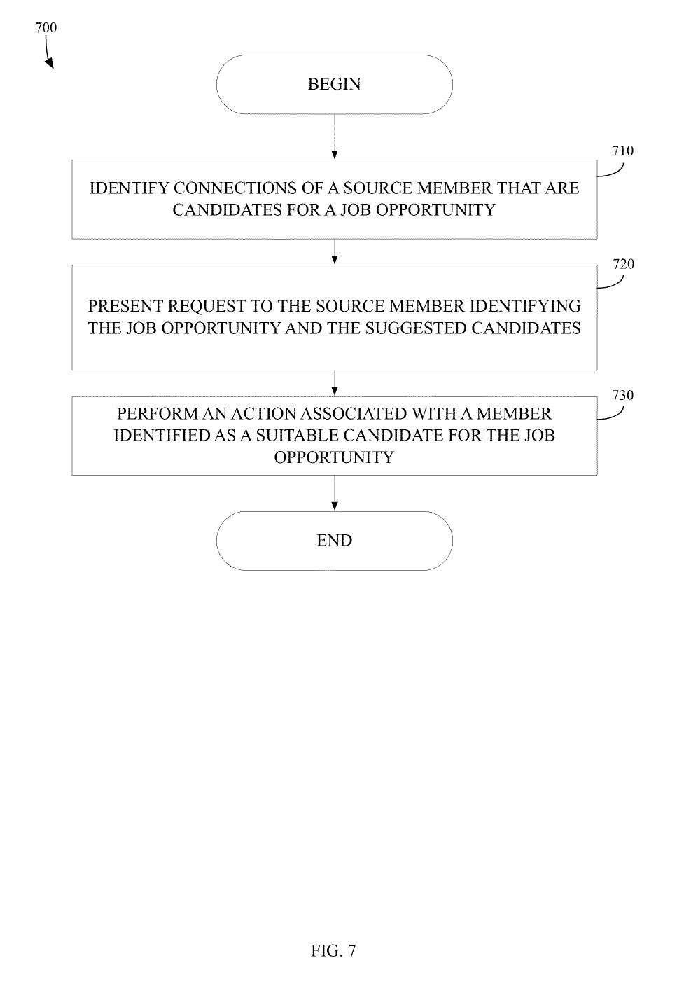

FIG. 7 is a flow diagram illustrating an example method 700 for identifying job candidates for an available job and performing an action associated with a job candidate, consistent with some embodiments. In operation 710, the system identifies connections of a referral source member that are candidates for a job opportunity. For example, the referral source module 420 may identify members as suitable candidates for an available job opportunity.

In operation 720, the system presents a request to the source member identifying the job opportunity and the candidates. For example, the action module 430 may display a widget that presents information identifying the candidates and/or the job opportunity via a web page presented by the social networking service, may send a message to the source member that includes information identifying the candidates and/or the job opportunity, and so on.

In some example embodiments, the system may present this information in the form of a personal request from the given member, in order add relevance to the request, which may cause the source member to respond, among other things. For example, the source member may select one or more of the identified candidates to be nominated for the job opportunity. The source member may use knowledge of a candidate's skills, professional reputation, and/or professional interests to decide whether to nominate a particular candidate for the job opportunity.

In operation 730, the system performs an action associated with a member identified as a suitable candidate for the job opportunity. For example, the action module 430 may displays an indication that the source member referred a candidate for the job opportunity. For example, the action module 430 may display information to the given member that indicates the source member has referred one or more of his/her connections to the available job opportunity. As another example, the action module 430 may notify the given member that the source member has nominated the candidate for the available job opportunity. As another example, the action module 430 may automatically present a user interface element that performs the action associated with the member identified as the job referral source when the user interface element is activated by the given member.

The following user interface examples illustrate various actions that may be performed in order to identify and/or otherwise display information associated with members as job referral sources.

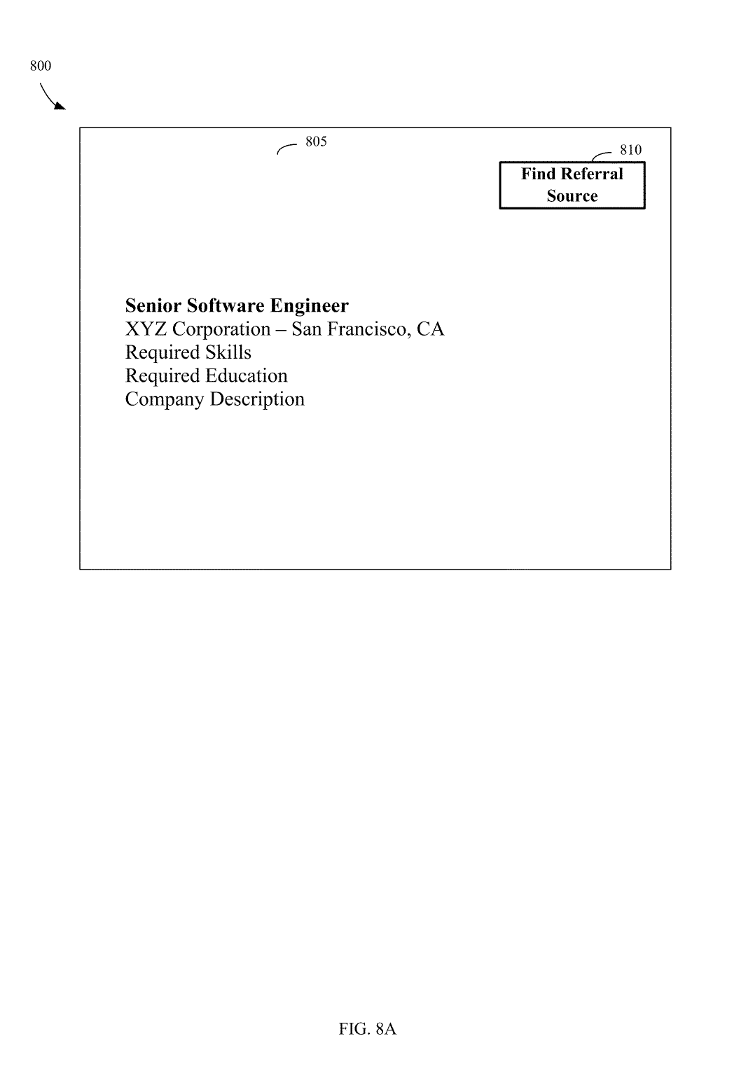

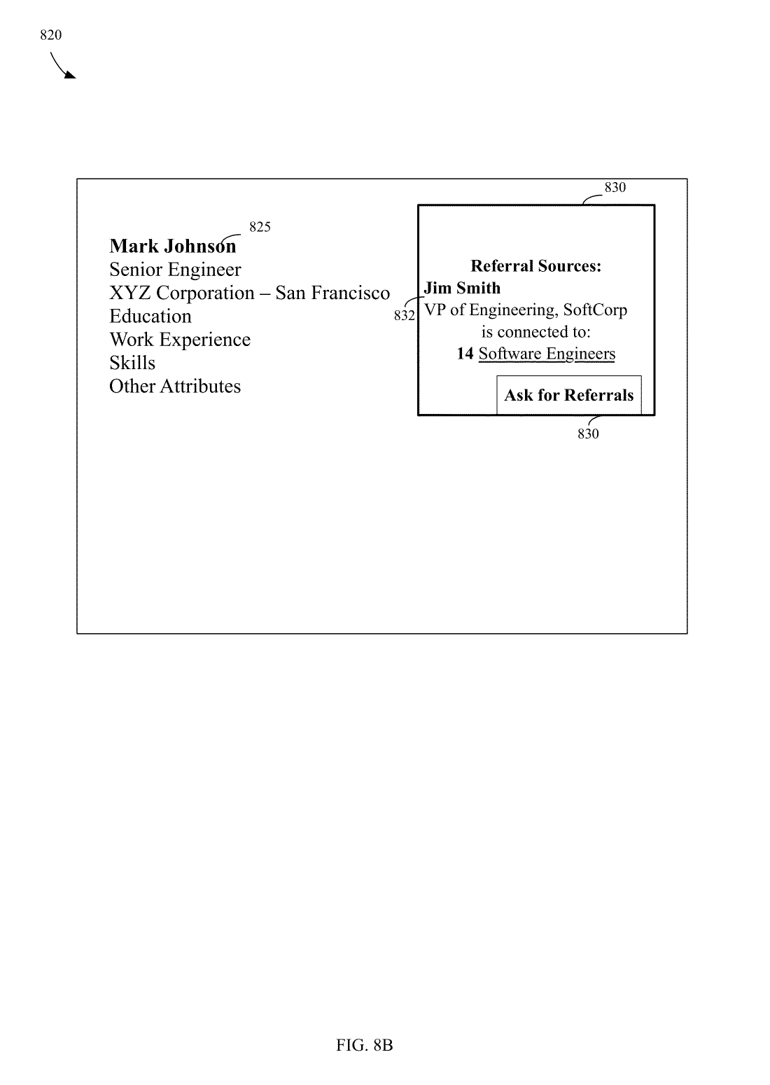

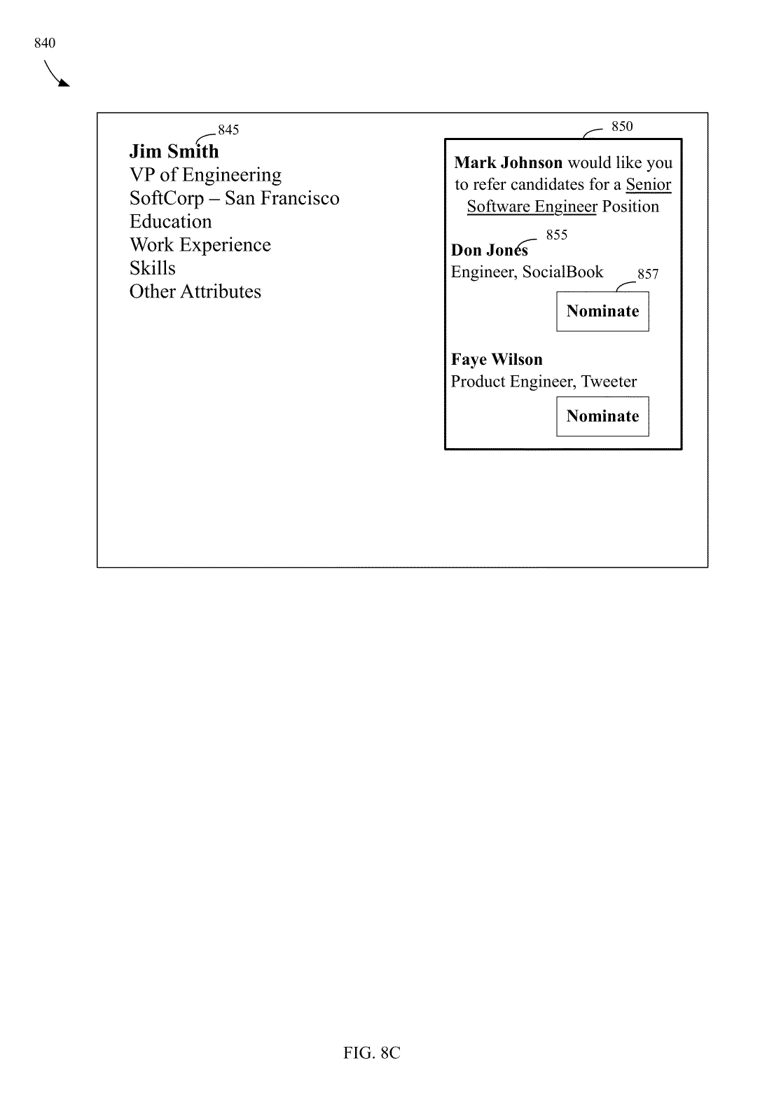

FIG. 8A-8C are display diagrams depicting the display of job referral information within a social network, consistent with some embodiments. FIG. 8A depicts a job listing page 800 that includes job description information 805 and a user-selectable button 810 that, when selected, initiates a method to identify a member as a job referral source.

FIG. 8B depicts a page 820 displayed by a social networking service for a member M of a social network that is employed by a company associated with an available job. The page 820 includes profile information 825 and a widget 830 that displays information 832 associated with the member M1 identified by the methods described herein as the job referral source for an available job associated with the company that employs the member M. The widget 830 may also display information identifying the available job and/or indicating reasons why the member M1 is suggested as a job referral source for this job. The widget 830 also displays a user interface element 834, which when activated, will generate a personal request to the job referral source member M1 for nominations of candidates suitable for the job. The member M1 may be notified via an electronic message, or a via a widget displayed on the social networking site.

FIG. 8C depicts a page 840 displayed by a social networking service for a member M1 identified as a job referral source. The page 840 includes member profile information 845 and a widget 850 that displays various types of information, including profile information for a member M who sent the request, information describing the available job opportunity, and profile information for one or more members (M2s) 855 connected to the member M1 that are suitable job candidates for the available job. The widget 850 also displays one or more user interface elements 857 associated with members (M2s), that the member M1 may activate to notify the member M that the selected member M2 is a suitable candidate for the job. The member M could be notified via an electronic message or via the social networking service. In addition, another representative of the company, such as a recruiter, may be notified of the selection of a member M2 as a potential job candidate. The member M, or a recruiter, could then contact the nominated member M2 regarding the job opportunity via an electronic message, which may, in some cases, be transmitted by the social networking service. The member M, or the recruiter, may refer to the member M1 as the referral source when contacting the member M2, to increase the relevance of the message by presenting the social context, among other things.

Of course, the user interfaces may display other types of information not shown in the Figures.

### CONCLUSION

The various operations of example methods described herein may be performed, at least partially, by one or more processors that are temporarily configured (e.g., by software) or permanently configured to perform the relevant operations. Whether temporarily or permanently configured, such processors may constitute processor-implemented modules, engines, objects or devices that operate to perform one or more operations or functions. The modules, engines, objects and devices referred to herein may, in some example embodiments, comprise processor-implemented modules, engines, objects and/or devices.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

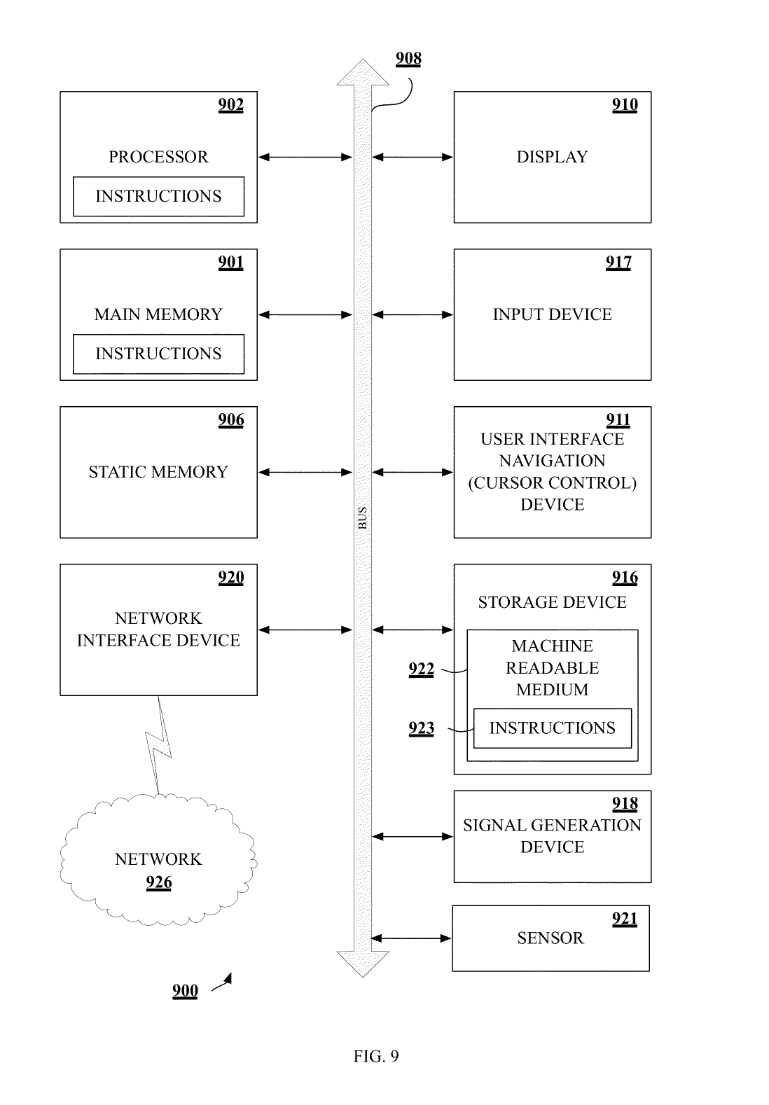

FIG. 9 is a block diagram of a machine in the form of a computer system or computing device within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in a peer-to-peer (or distributed) network environment. In some embodiments, the machine will be a desktop computer, or server computer, however, in alternative embodiments, the machine may be a tablet computer, a mobile phone, a personal digital assistant, a personal audio or video player, a global positioning device, a set-top box, a web appliance, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processor 902 (e.g., a central processing unit (CPU), a graphics processing unit (GPU) or both), a main memory 901 and a static memory 906, which communicate with each other via a bus 908. The computer system 900 may further include a display unit 910, an alphanumeric input device 917 (e.g., a keyboard), and a user interface (UI) navigation device 911 (e.g., a mouse). In one embodiment, the display, input device and cursor control device are a touch screen display. The computer system 900 may additionally include a storage device 916 (e.g., drive unit), a signal generation device 918 (e.g., a speaker), a network interface device 920, and one or more sensors 921, such as a global positioning system sensor, compass, accelerometer, or other sensor.

The drive unit 916 includes a machine-readable medium 922 on which is stored one or more sets of instructions and data structures (e.g., software 923) embodying or utilized by any one or more of the methodologies or functions described herein. The software 923 may also reside, completely or at least partially, within the main memory 901 and/or within the processor 902 during execution thereof by the computer system 900, the main memory 901 and the processor 902 also constituting machine-readable media.

While the machine-readable medium 922 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 923 may further be transmitted or received over a communications network 926 using a transmission medium via the network interface device 920 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although some embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A method comprising:
for a given member of a social network service, receiving information associated with an available job opportunity;
identifying a member of the social network service that is connected to the given member as a job referral source; and
performing an action associated with the member identified as the job referral source.

2. The method of claim 1, wherein identifying a member of the social network service that is connected to the given member as a job referral source includes performing an algorithmic process to identify the member of the social network that is connected to the given member as a job referral source, the algorithmic process matching attributes assigned to members of the social network service that are second degree connections to the given member to requirements presented by the available job opportunity.

3. The method of claim 1, wherein identifying a member of the social network service that is connected to the given member as a job referral source includes identifying a member of the social network service that is connected to one or more other members determined to be suitable candidates for the available job opportunity.

4. The method of claim 1, wherein identifying a member of the social network service that is connected to the given member as a job referral source includes:
calculating a suitability score for one or more members of the social network service that are connected to the identified member, the suitability score associated with a member being a suitable candidate for the available job opportunity; and
when the calculated suitability score is above a threshold score, determining the identified member is a job referral source for the available job opportunity.

5. The method of claim 1, wherein identifying a member of the social network service that is connected to the given member as a job referral source includes identifying a member of the social network service that is connected to one or more other members that have work experience attributes similar to work experience requirements identified in the available job opportunity.

6. The method of claim 1, wherein identifying a member of the social network service that is connected to the given member as a job referral source includes identifying a member of the social network service that is connected to one or more other members that have education experience attributes similar to education experience requirements identified in the available job opportunity.

7. The method of claim 1, wherein identifying a member of the social network service that is connected to the given member as a job referral source includes identifying a member of the social network service that is connected to one or more other members that have skills attributes similar to skills requirements identified in the available job opportunity.

8. The method of claim 1, wherein the given member of the social network service is employed by a company that is associated with the available job opportunity.

9. The method of claim 1, wherein performing an action associated with the member identified as the job referral source includes sending a request from the given member to the identified member.

10. The method of claim 1, wherein performing an action associated with the member identified as the job referral source includes sending a request from the given member to the identified member, the method further comprising:
automatically presenting to the given member information identifying the available job opportunity and information identifying the member identified as the job referral source.

11. The method of claim 1, wherein performing an action associated with the member identified as the job referral source includes sending a request from the given member to the identified member, the method further comprising:
automatically presenting a user interface element that performs the action associated with the member identified as the job referral source when the user interface element is activated by the given member.

12. The method of claim 1, wherein performing an action associated with the member identified as the job referral source includes presenting information identifying members connected to the identified member as suitable candidates for the available job opportunity.

13. The method of claim 1, wherein performing an action associated with the member identified as the job referral source includes presenting information identifying the available job opportunity and information identifying members connected to the identified member as suitable candidates for the available job opportunity.

14. The method of claim 1, further comprising:
identifying a member of the social networking service as a candidate for the available job opportunity, wherein the member is connected to the member identified as the job referral source; and
performing an action associated with the member identified as the candidate for the available job opportunity.

15. The method of claim 1, further comprising:
identifying a member of the social networking service as a candidate for the available job opportunity, wherein the member is connected to the member identified as the job referral source; and
sending a message to the given member that includes information identifying the candidate for the available job opportunity.

16. A system, comprising:
a job information module that is configured to access information associated with an available job opportunity;
a referral source module that is configured to identify, for a given member employed by a company associated with the available job opportunity, a member of the social network service as a job referral source; and
an action module that is configured to perform an action associated with the member identified as the job referral source.

17. The system of claim 16, wherein the referral source module is configured to perform an algorithmic process to identify the member of the social network that is connected to the given member as a job referral source, the algorithmic process matching attributes assigned to members of the social network service that are second degree connections to the given member to requirements presented by the available job opportunity.

18. The system of claim 16, wherein the referral source module is configured to identify a member of the social network service that is connected to one or more other members determined to be suitable candidates for the available job opportunity.

19. The system of claim 16, wherein the referral source module is configured to:
calculate a suitability score for one or more members of the social network service that are connected to the identified member, the suitability score associated with a member being a suitable candidate for the available job opportunity; and
when the calculated suitability score is above a threshold score, determine the identified member is a job referral source for the available job opportunity.

20. The system of claim 16, wherein the referral source module is configured to identify a member of the social network service that is connected to one or more other members that have member attributes similar to requirements identified in the available job opportunity.

21. The system of claim 16, wherein the action module is configured to present information identifying the available job opportunity and information identifying members connected to the identified member as suitable candidates for the available job opportunity via a widget within a web page displayed by the social network service.

22. The system of claim 21, wherein the action module is further configured to perform an action associated with a member identified as a suitable candidate for the available job opportunity.

23. A computer-readable storage medium whose contents, when executed by a computing system, cause the computing system to perform operations, comprising:
for a given member of a social network service, receiving information associated with an available job opportunity;
identifying a member of the social network service that is connected to the given member as a job referral source; and
performing an action associated with the member identified as the job referral source.

24. The computer-readable storage medium of claim 23, wherein identifying a member of the social network service that is connected to the given member as a job referral source includes performing an algorithmic process to identify the member of the social network that is connected to the given member as a job referral source, the algorithmic process matching attributes assigned to members of the social network service that are second degree connections to the given member to requirements presented by the available job opportunity.

25. The computer-readable storage medium of claim 23, wherein identifying a member of the social network service that is connected to the given member as a job referral source includes identifying a member of the social network service that is connected to one or more other members determined to be suitable candidates for the available job opportunity.
